(19) United States
(12) Patent Application Publication
(10) Pub. No.: US 2012/0327223 A1
(43) Pub. Date: Dec. 27, 2012

(54) OBJECT DETECTING DEVICE AND INFORMATION ACQUIRING DEVICE

(75) Inventor: Nobuo IWATSUKI, Anpachi-Gun (JP)

(73) Assignee: Sanyo Electric Co., Ltd., Moriguchi-shi (JP)

(21) Appl. No.: 13/605,546

(22) Filed: Sep. 6, 2012

Related U.S. Application Data
(63) Continuation of application No. PCT/JP2011/075387, filed on Nov. 4, 2011.

(30) Foreign Application Priority Data
Mar. 25, 2011 (JP) 2011-68478

(51) Int. Cl. H04N 7/18

(52) U.S. Cl. 348/135; 348/E07.085

(57) ABSTRACT

An information acquiring device is provided with a light emitting device, a light receiving device, and a base plate having a heat conductivity. The light emitting device has a laser light source, a collimator lens, a diffractive optical element, a mirror which reflects laser light in a direction toward the diffractive optical element, and a housing having a heat conductivity. A side surface of the housing opposite to a reflecting direction of laser light by the mirror is formed into a flat surface, and the housing is mounted on a support plate in such a manner that the flat surface is placed on a top surface of the support plate. Heat generated in the laser light source is efficiently transferred to the support plate via the housing.

This application claims priority under 35 U.S.C. Section 119 of Japanese Patent Application No. 2011-68478 filed Mar. 25, 2011, entitled “OBJECT DETECTING DEVICE AND INFORMATION ACQUIRING DEVICE”. The disclosure of the above application is incorporated herein by reference.

### BACKGROUND OF THE INVENTION

1. Field of the Invention

The present invention relates to an object detecting device for detecting an object in a target area, based on a state of reflected light when light is projected onto the target area, and an information acquiring device incorporated with the object detecting device.

2. Disclosure of Related Art

Conventionally, there has been developed an object detecting device using light in various fields. An object detecting device incorporated with a so-called distance image sensor is operable to detect not only a two-dimensional image on a two-dimensional plane but also a depthwise shape or a movement of an object to be detected. In such an object detecting device, light in a predetermined wavelength band is projected from a laser light source or an LED (Light Emitting Diode) onto a target area, and light reflected on the target area is received by a light receiving element such as a CMOS image sensor. Various types of sensors are known as the distance image sensor.

A distance image sensor configured to irradiate a target area with laser light having a predetermined dot pattern is operable to receive reflected light of laser light having a dot pattern reflected on the target area by a light receiving element. Then, a distance to each portion of an object to be detected (an irradiation position of each dot on an object to be detected) is detected, based on a light receiving position of each dot on the light receiving element, using a triangulation method (see e.g. pp. 1279-1280, the 19th Annual Conference Proceedings (Sep. 18-20, 2001) by the Robotics Society of Japan).

In the object detecting device thus constructed, a laser light source, a collimator lens, and a diffractive optical element are used as optical elements of an optical system for projecting laser light having a dot pattern. If these optical elements are aligned in a projecting direction, the size of the optical system in the projecting direction increases. If a temperature adjusting element such as a Peltier element is disposed, in addition to these optical elements, for suppressing a wavelength variation of the laser light source resulting from a temperature change, the size of the projection optical system in the projecting direction further increases. However, since the optical characteristic of the diffractive optical element depends on the wavelength of laser light, an arrangement for suppressing a temperature change of the laser light source is required. Further, if the laser light source is kept in a high-temperature condition, the life of the laser light source may be shortened.

### SUMMARY OF THE INVENTION

A first aspect of the invention is directed to an information acquiring device. The information acquiring device according to the first aspect is provided with a light emitting device which irradiates a target area with laser light having a dot pattern; a light receiving device which is disposed in alignment with the light emitting device, and captures an image of the target area; and a support plate on which the light emitting device and the light receiving device are mounted, the support plate having a heat conductivity. The light emitting device includes a laser light source; a collimator lens which converts laser light emitted from the laser light source into parallel light; a diffractive optical element which converts laser light converted as the parallel light into laser light having the dot pattern; a mirror which reflects the laser light transmitted through the collimator lens in a direction toward the diffractive optical element; and a housing which holds the laser light source, the collimator lens, the mirror and the diffractive optical element in such a manner as to linearly align the laser light source, the collimator lens and the mirror, the housing having a heat conductivity. The light emitting device is configured in such a manner that a side surface of the housing opposite to a reflecting direction of laser light by the mirror is formed into a flat surface, and the housing is mounted on the support plate in such a manner that the flat surface is placed on a top surface of the support plate.

A second aspect of the invention is directed to an object detecting device. The object detecting device according to the second aspect has the information acquiring device according to the first aspect.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an arrangement of an object detecting device embodying the invention.

FIG. 2 is a diagram showing an arrangement of an information acquiring device and an information processing device in the embodiment.

FIGS. 3A and 3B are diagrams respectively showing an irradiation state of laser light onto a target area, and a light receiving state of laser light on an image sensor in the embodiment.

FIG. 4A is an exploded perspective view of a light emitting device in the embodiment, and FIG. 4B is a rear view showing an arrangement of a laser holder.

FIGS. 5A and 5B are perspective views showing an arrangement of the light emitting device in the embodiment.

FIG. 6 is a diagram showing an assembling process of the information acquiring device in the embodiment.

FIG. 7 is a diagram showing the assembling process of the information acquiring device in the embodiment.

FIGS. 8A and 8B are diagrams showing the assembling process of the information acquiring device in the embodiment.

FIGS. 9A and 9B are diagrams respectively showing an arrangement of the information acquiring device in the embodiment and an arrangement of an information acquiring device in a comparative example.

FIGS. 10A and 10B are diagrams showing an arrangement of an information acquiring device as a modification example.

The drawings are provided mainly for describing the present invention, and do not limit the scope of the present invention.

### DESCRIPTION OF PREFERRED EMBODIMENTS

In the following, an embodiment of the invention is described referring to the drawings. In the embodiment, there is exemplified an information acquiring device for irradiating a target area with laser light having a predetermined dot pattern.

In the embodiment, a rise-up mirror 130 corresponds to a “mirror” in the claims. A DOE 140 corresponds to a “diffractive optical element” in the claims. Abase plate 300 corresponds to a “support plate” in the claims. The description regarding the correspondence between the claims and the embodiment is merely an example, and the claims are not limited by the description of the embodiment.

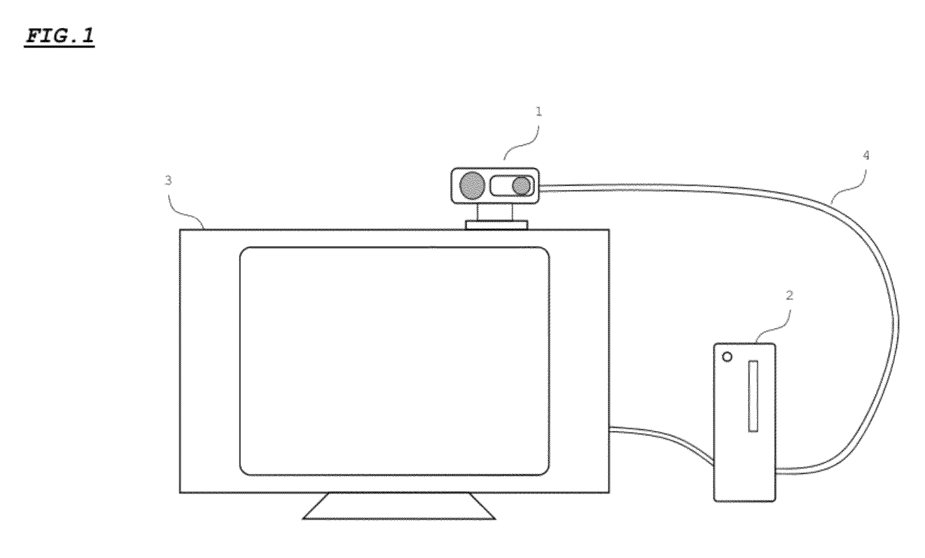

A schematic arrangement of an object detecting device according to the first embodiment is described. As shown in FIG. 1, the object detecting device is provided with an information acquiring device 1, and an information processing device 2. ATV 3 is controlled by a signal from the information processing device 2.

The information acquiring device 1 projects infrared light to the entirety of a target area, and receives reflected light from the target area by a CMOS image sensor to thereby acquire a distance (hereinafter, called as “three-dimensional distance information”) to each part of an object in the target area. The acquired three-dimensional distance information is transmitted to the information processing device 2 through a cable 4.

The information processing device 2 is e.g. a controller for controlling a TV or a game machine, or a personal computer. The information processing device 2 detects an object in a target area based on three-dimensional distance information received from the information acquiring device 1, and controls the TV 3 based on a detection result.

For instance, the information processing device 2 detects a person based on received three-dimensional distance information, and detects a motion of the person based on a change in the three-dimensional distance information. For instance, in the case where the information processing device 2 is a controller for controlling a TV, the information processing device 2 is installed with an application program operable to detect a gesture of a user based on received three-dimensional distance information, and output a control signal to the TV 3 in accordance with the detected gesture. In this case, the user is allowed to control the TV 3 to execute a predetermined function such as switching the channel or turning up/down the volume by performing a certain gesture while watching the TV 3.

Further, for instance, in the case where the information processing device 2 is a game machine, the information processing device 2 is installed with an application program operable to detect a motion of a user based on received three-dimensional distance information, and operate a character on a TV screen in accordance with the detected motion to change the match status of a game. In this case, the user is allowed to play the game as if the user himself or herself is the character on the TV screen by performing a certain action while watching the TV 3.

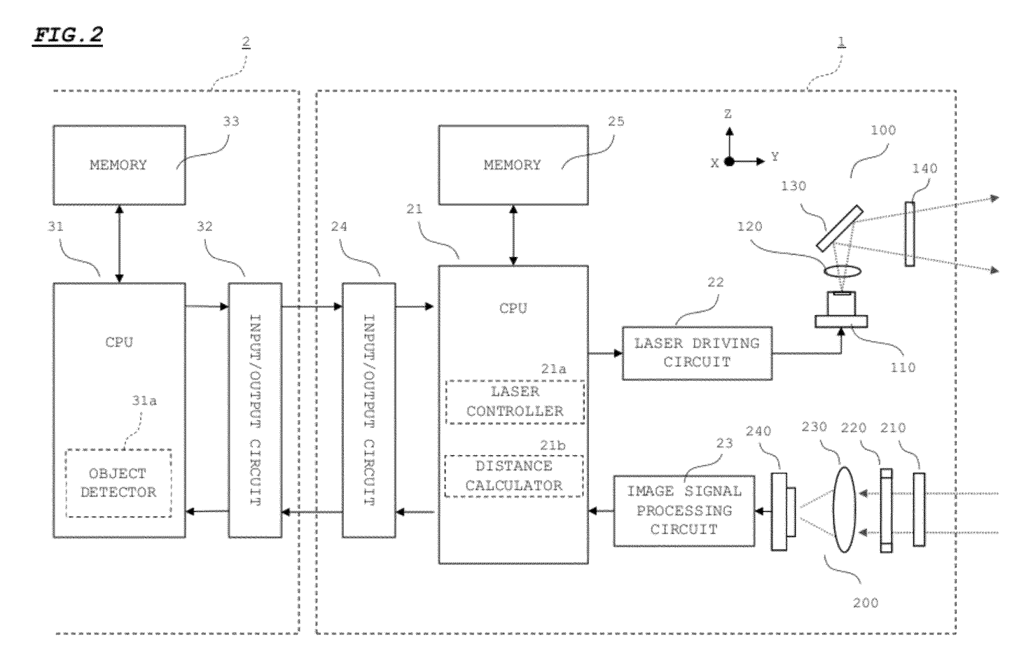

FIG. 2 is a diagram showing an arrangement of the information acquiring device 1 and the information processing device 2. In FIG. 2, to simplify the description, XYZ axes orthogonal to each other are shown to indicate directions regarding a projection optical system 100 and a light receiving optical system 200.

The information acquiring device 1 is provided with the projection optical system 100 and the light receiving optical system 200 which constitute an optical section. The projection optical system 100 and the light receiving optical system 200 are provided in the information acquiring device 1 to be aligned in Z-axis direction.

The projection optical system 100 is provided with a laser light source 110, a collimator lens 120, and a rise-up mirror 130, and a DOE (Diffractive Optical Element) 140. Further, the light receiving optical system 200 is provided with a filter 210, an aperture 220, an imaging lens 230, and a CMOS image sensor 240. In addition to the above, the information acquiring device 1 is provided with a CPU (Central Processing Unit) 21, a laser driving circuit 22, an image signal processing circuit 23, an input/output circuit 24, and a memory 25, which constitute a circuit section.

The laser light source 110 outputs laser light having a narrow wavelength band of about 830 nm in a direction (plus Z-axis direction) away from the light receiving optical system 200. The collimator lens 120 converts the laser light emitted from the laser light source 110 into light (hereinafter, simply called as “parallel light”) slightly expanded from parallel light. The rise-up mirror 130 reflects laser light entered from the collimator lens 120 side in a direction (plus Y-axis direction) toward the DOE 140.

The DOE 140 has a diffraction pattern on a light incident surface thereof. Laser light entered to the DOE 140 is converted into laser light having a dot pattern by a diffractive action of the diffraction pattern, and is irradiated onto a target area. The diffraction pattern has e.g. a structure such that a step-type diffraction hologram is formed with a predetermined pattern. The pattern and the pitch of the diffraction hologram are adjusted in such a manner that laser light collimated by the collimator lens 120 as parallel light is converted into laser light having a dot pattern.

The DOE 140 irradiates a target area with laser light entered from the rise-up mirror 130 as laser light having a radially spreading dot pattern. The size of each dot of the dot pattern corresponds to the beam size of laser light to be entered to the DOE 140. Laser light (zero-th order light) which is not diffracted by the DOE 140 is transmitted through the DOE 140 and travels in a forward direction.

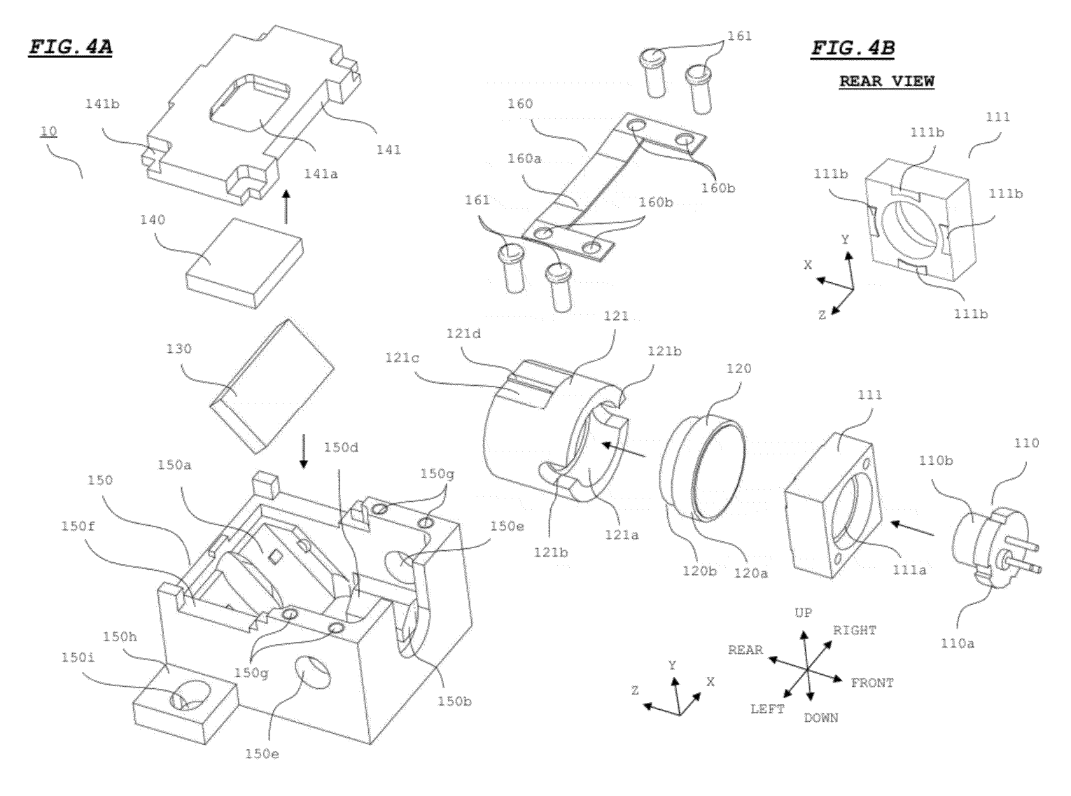

The detailed arrangement of the projection optical system 100 will be described later referring to FIGS. 4A through 8B.

Laser light reflected on a target area is entered to the imaging lens 230 via the filter 210 and the aperture 220.

The filter 210 is a band-pass filter which transmits light of a wavelength band including the emission wavelength (of about 830 nm) of the laser light source 110, and blocks light of a wavelength band of visible light. The aperture 220 converts external light into convergent light in accordance with the F-number of the imaging lens 230. The imaging lens 230 condenses the light entered through the aperture 220 on the CMOS image sensor 240.

The CMOS image sensor 240 receives light condensed on the imaging lens 230, and outputs a signal (electric charge) in accordance with a received light amount to the image signal processing circuit 23 pixel by pixel. In this example, the CMOS image sensor 240 is configured in such a manner that the output speed of signals to be outputted from the CMOS image sensor 240 is set high so that a signal (electric charge) at each pixel can be outputted to the image signal processing circuit 23 with high response from a light receiving timing at each pixel.

The CPU 21 controls the parts of the information acquiring device 1 in accordance with a control program stored in the memory 25. By the control program, the CPU 21 has functions of a laser controller 21a for controlling the laser light source 110 and a distance calculator 21b for generating three-dimensional distance information.

The laser driving circuit 22 drives the laser light source 110 in accordance with a control signal from the CPU 21. The image signal processing circuit 23 controls the CMOS image sensor 240 to successively read signals (electric charges) from the pixels, which have been generated in the CMOS image sensor 240, line by line. Then, the image signal processing circuit 23 outputs the read signals successively to the CPU 21. The CPU 21 calculates a distance from the information acquiring device 1 to each portion of an object to be detected, by a processing to be implemented by the distance calculator 21b, based on the signals (image signals) to be supplied from the image signal processing circuit 23. The input/output circuit 24 controls data communications with the information processing device 2.

The information processing device 2 is provided with a CPU 31, an input/output circuit 32, and a memory 33. The information processing device 2 is provided with e.g. an arrangement for communicating with the TV 3, or a drive device for reading information stored in an external memory such as a CD-ROM and installing the information in the memory 33, in addition to the arrangement shown in FIG. 2. The arrangements of the peripheral circuits are not shown in FIG. 2 to simplify the description.

The CPU 31 controls each of the parts of the information processing device 2 in accordance with a control program (application program) stored in the memory 33. By the control program, the CPU 31 has a function of an object detector 31a for detecting an object in an image. The control program is e.g. read from a CD-ROM by an unillustrated drive device, and is installed in the memory 33.

For instance, in the case where the control program is a game program, the object detector 31a detects a person and a motion thereof in an image based on three-dimensional distance information supplied from the information acquiring device 1. Then, the information processing device 2 causes the control program to execute a processing for operating a character on a TV screen in accordance with the detected motion.

Further, in the case where the control program is a program for controlling a function of the TV 3, the object detector 31a detects a person and a motion (gesture) thereof in the image based on three-dimensional distance information supplied from the information acquiring device 1. Then, the information processing device 2 causes the control program to execute a processing for controlling a predetermined function (such as switching the channel or adjusting the volume) of the TV 3 in accordance with the detected motion (gesture).

The input/output circuit 32 controls data communication with the information acquiring device 1.

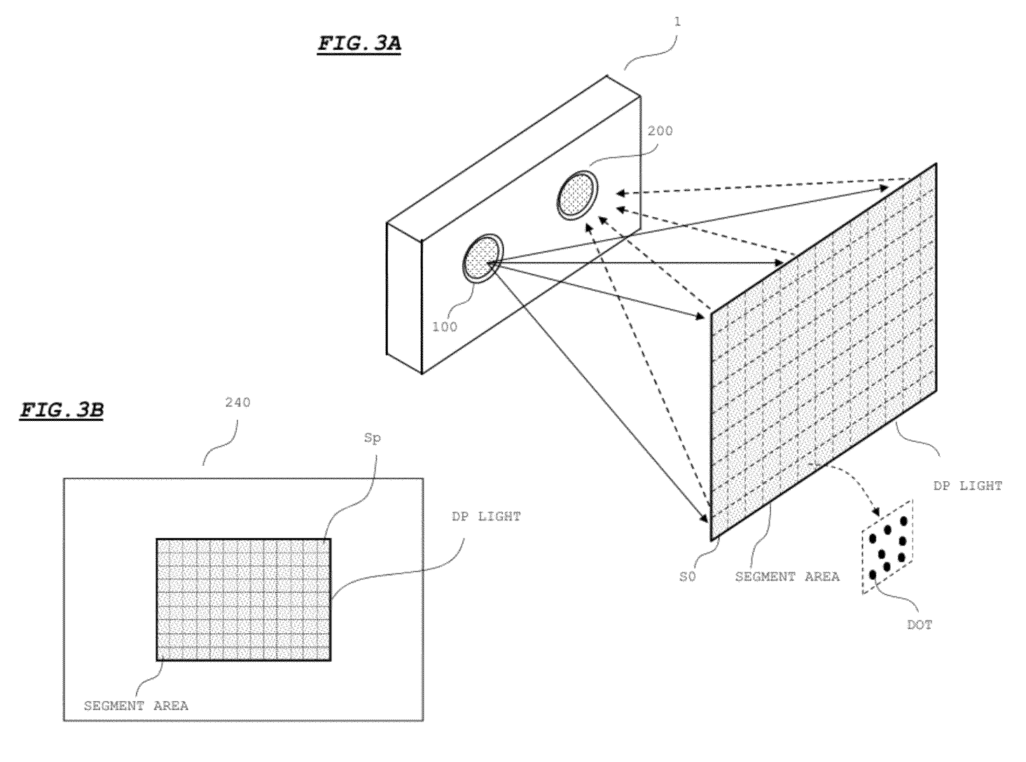

FIG. 3A is a diagram schematically showing an irradiation state of laser light onto a target area. FIG. 3B is a diagram schematically showing a light receiving state of laser light on the CMOS image sensor 240. To simplify the description, FIG. 3B shows a light receiving state in the case where a flat plane (screen) is disposed on a target area.

The projection optical system 100 irradiates a target area with laser light having a dot pattern (hereinafter, the entirety of the laser light having the dot pattern is called as “DP light”). FIG. 3A shows a light flux area of DP light by a solid-line frame. In the light flux of DP light, dot areas (hereinafter, simply called as “dots”) in which the intensity of laser light is increased by a diffractive action of the DOE 140 locally appear in accordance with the dot pattern by the diffractive action of the DOE 140.

To simplify the description, in FIG. 3A, a light flux of DP light is divided into segment areas arranged in the form of a matrix. Dots locally appear with a unique pattern in each segment area. The dot appearance pattern in a certain segment area differs from the dot appearance patterns in all the other segment areas. With this configuration, each segment area is identifiable from all the other segment areas by a unique dot appearance pattern of the segment area.

When a flat plane (screen) exists in a target area, the segment areas of DP light reflected on the flat plane are distributed in the form of a matrix on the CMOS image sensor 240, as shown in FIG. 3B. For instance, light of a segment area SO in the target area shown in FIG. 3A is entered to a segment area Sp shown in FIG. 3B, on the CMOS image sensor 240. In FIG. 3B, a light flux area of DP light is also indicated by a solid-line frame, and to simplify the description, a light flux of DP light is divided into segment areas arranged in the form of a matrix in the same manner as shown in FIG. 3A.

The distance calculator 21b is operable to detect a position of each segment area on the CMOS image sensor 240 for detecting a distance to a position of an object to be detected corresponding to the segment area, based on the detected position of the segment area, using a triangulation method. The details of the above detection method is disclosed in e.g. pp. 1279-1280, the 19th Annual Conference Proceedings (Sep. 18-20, 2001) by the Robotics Society of Japan.

The optical characteristic of the DOE 140 depends on the wavelength of laser light. If the temperature of the laser light source 110 changes, the wavelength of laser light is also likely to change. The dot pattern of laser light is also likely to change, as the wavelength of laser light changes. If the dot pattern changes as described above, it is impossible to accurately perform a dot pattern matching operation. As a result, detection precision of a distance to an object to be detected may be lowered.

In the above case, a temperature adjusting element such as a Peltier element maybe used as temperature adjusting means for the laser light source. Use of the Peltier element, however, requires to increase the thickness of the Peltier element itself or increase the size of a heat radiating plate for radiating heat generated in the Peltier element itself.

Further, if the projection optical system 100 is aligned in the projecting direction of light toward a target area, the size of the projection optical system 100 in the projecting direction increases. On the other hand, it is necessary to set a certain distance between the projection optical system 100 and the light receiving optical system 200 for distance measurement based on a triangulation method. If the size of the projection optical system 100 in the projecting direction increases as described above, the overall outer dimensions of the information acquiring device 1 increase, taking into consideration of the distance between the projection optical system 100 and the light receiving optical system 200.

In view of the above, in the embodiment, there is provided an arrangement for efficiently radiating heat of the laser light source 110, while suppressing an increase in the size of the information acquiring device 1.

FIG. 4A is an exploded perspective view showing an arrangement example of a light emitting device 10 in the embodiment. The light emitting device 10 is a device constructed by assembling the projection optical system 100 shown in FIG. 2 and other components into one unit. In FIG. 4A, front and rear directions, left and right directions, and up and down directions are indicated along with XYZ axes shown in FIG. 2. Up and down directions are in parallel to Y-axis direction, left and right directions are in parallel to X-axis direction, and front and rear directions are in parallel to Z-axis direction.

Referring to FIG. 4A, the light emitting device 10 is provided with a laser holder 111, a lens holder 121, a DOE holder 141, a housing 150, and a pressing spring 160, in addition to the laser light source 110, the collimator lens 120, the rise-up mirror 130, and the DOE 140.

As shown in FIG. 4A, the laser light source 110 has a base member 110a and a CAN 110b. The base member 110a has a circular shape in front view, with the outer circumference thereof being partially cut away. Further, the collimator lens 120 has a large diametrical portion 120a with a cylindrical outer circumferential surface, and a small diametrical portion 120b with a diameter thereof smaller than that of the large diametrical portion 120a.

The laser holder 111 has a square shape in front view, and is made of a frame member with a circular opening 111a formed in the center thereof. The opening 111a passes through the laser holder 111 in front and rear directions, and is so configured that two cylindrical holes with the diameters thereof different from each other are coaxially aligned. The diameter of the front hole of the opening 111a is set larger than the diameter of the rear hole of the opening 111a, and a ring-shaped step portion is formed on a boundary portion where the diameter changes. The diameter of the front hole of the opening 111a is set slightly larger than the diameter of the base member 110a of the laser light source 110. The laser light source 110 is positioned relative to the laser holder 111 by inserting the base member 110a into the opening 111a from the front side to such an extent that a rear surface of the base member 110a of the laser light source 110 is abutted against the step portion in the opening 111a. In this state, an adhesive is applied in the cutaway formed in the outer circumference of the base member 110a, whereby the laser light source 110 is adhesively fixed to the laser holder 111.

The laser holder 111 is made of a material having a high heat conductivity. For instance, the laser holder 111 is made of a material such as zinc, which has a heat conductivity as high as 121 W/(m·K), and is manufactured by a general die-cast molding.

As shown in FIG. 4B, four step portions 111b higher than the other portion by one step are formed at an outer circumference on a back surface of the laser holder 111. The four step portions 111b have the same height and shape as each other. An end surface of each of the four step portions 111b in a height direction is in parallel to X-Y plane. As will be described later, the position of the laser light source 110 is adjusted by displacing the laser holder 111 in an in-plane direction of X-Y plane in a state that the step portions 111b are in contact with an outer side surface of the housing 150. In the adjustment, displacement of the laser holder 111 can be smoothly performed, because a contact surface between the step portions 111b and the outer side surface of the housing 150 is small.

Referring back to FIG. 4A, the lens holder 121 has a substantially circular shape in front view, and is made of a frame member with an opening 121a formed in the center thereof. The opening 121a passes through the lens holder 121 in front and rear directions, and is so configured that two cylindrical holes with the diameters thereof different from each other are coaxially aligned. The diameter of the front hole of the opening 121a is set larger than the diameter of the rear hole of the opening 121a, and a ring-shaped step portion is formed on a boundary portion where the diameter changes. The diameter of the front hole of the opening 121a is set slightly larger than the diameter of the large diametrical portion 120a of the collimator lens 120. The collimator lens 120 is positioned relative to the lens holder 121 by inserting the large diametrical portion 120a into the opening 121a from the front side to such an extent that a rear surface of the large diametrical portion 120a of the collimator lens 120 is abutted against the step portion in the opening 121a. In this state, the collimator lens 120 is adhesively fixed to the lens holder 121.

A recess 121c extending in front and rear directions is formed in a top surface of the lens holder 121. A protrusion 121d extending in front and rear directions is formed on the recess 121c. Two grooves 121b are formed on side of the lens holder 121 so that an adhesive is allowed to flow in adhesively fixing the collimator lens 120 and the lens holder 121 to each other.

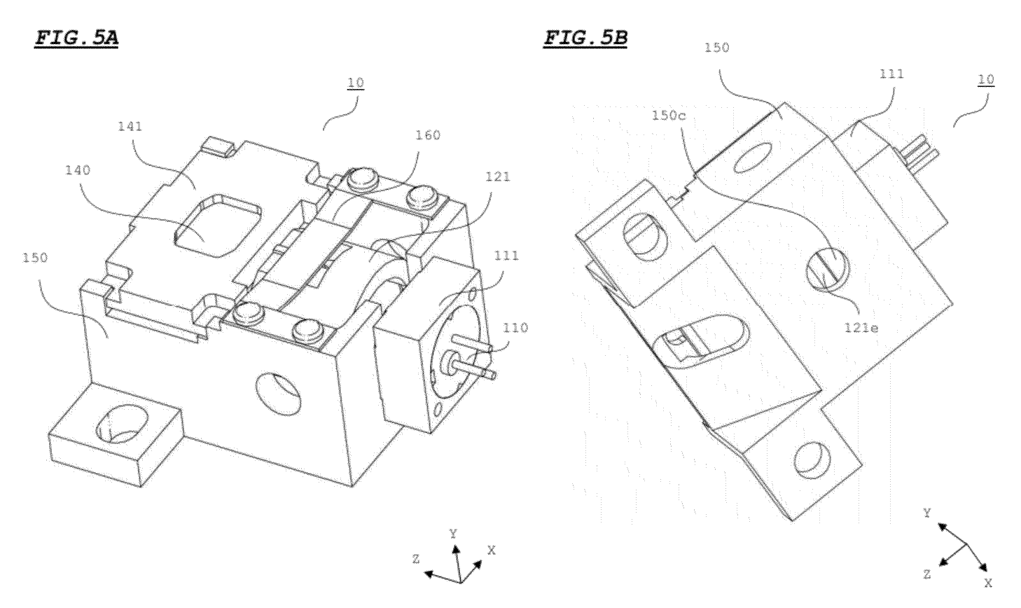

A rectangular groove 121e linearly extending in left and right directions (X-axis direction) is formed in a lower surface of the lens holder 121 (see FIG. 5B). The groove 121e is used in adjusting the position of the lens holder 121 in front and rear directions (Z-axis direction). The center of the protrusion 121d and the center of the groove 121e in a circumferential direction of the lens holder 121 are displaced from each other by 180 degrees. Accordingly, when the protrusion 121d faces right above, the groove 121e faces right below.

A step portion (not shown) for mounting the DOE 140 is formed on a lower surface of the DOE holder 141. Further, an opening 141a for guiding laser light toward a target area is formed in the center of the DOE holder 141. The DOE 140 is inserted into the DOE holder 141 from beneath the DOE holder 141, and is adhesively fixed to the DOE holder 141. Further, a step portion 141b for fixing the DOE holder 141 in the housing 150 is formed at left and right ends of the DOE holder 141.

The housing 150 has a rectangular shape in top plan view, and is made of a frame member having a bottom surface. The housing 150 is symmetrical in left and right directions with respect to a plane in parallel to Y-Z plane, except for portions where screw holes 150i are formed.

The housing 150 is made of a material having a high heat conductivity. For instance, the housing 150 is made of a material having a high heat conductivity, such as zinc whose heat conductivity is 121 W/(m·K) or magnesium whose heat conductivity is 157 W/(m·K), and is manufactured by a general die-cast molding. Zinc is somewhat inferior to magnesium in heat conductivity, but is advantageous in suppressing the manufacturing cost. A material suitable for the housing 150 is used depending on a condition.

As shown in FIG. 4A, a mirror mounting portion 150a with an inclination of 45° in an in-plane direction of Y-Z plane is formed on an inner rear portion of the housing 150. The rise-up mirror 130 is mounted on the mirror mounting portion 150a, and is adhesively fixed to the mirror mounting portion 150a. Further, a U-shaped opening 150b is formed in a front side surface of the housing 150. The width of the opening 150b in left and right directions is set larger than the diameter of the CAN 110b of the laser light source 110.

A hole 150c for guiding a Z-axis adjusting jig (not shown) into the groove 121e of the lens holder 121 is formed in the bottom surface of the housing 150 (see FIG. 5B). The diameter of the hole 150c is set larger than the Z-axis directional width of the groove 121e of the lens holder 121. Two holes 150e are formed in two respective side surfaces of the housing 150 aligned in left and right directions so that a UV adhesive is allowed to flow into the housing 150.

Further, a pair of slopes 150d facing each other is formed on lower ends of two inner side surfaces of the housing 150 aligned in left and right directions. The two slopes 150d are inclined downwardly at a certain angle with respect to a plane in parallel to X-Z plane. Displacement of the lens holder 121 in X-axis direction (left and right directions) is restricted by placing the lens holder 121 on the two slopes 150d.

Step portions 150f for mounting the DOE holder 141, and four screw holes 150g are formed on a top surface of the housing 150. The Z-axis directional width of each step portion 150f is set slightly larger than the width of the left/right step portion 141b of the DOE holder 141. Two flange portions 150h protruding outwardly of the housing 150 are respectively formed at lower ends of two outer side surfaces of the housing 150 aligned in left and right directions. Each of the two flange portions 150h is formed with the screw hole 150i for fixing the housing 150 onto the base plate 300 to be described later.

The pressing spring 160 is a resilient plate spring, and has a step portion 160a lower than the other portion by one step in the middle thereof. The pressing spring 160 has a symmetrical configuration in left and right directions. Four screw holes 160b for fixing the pressing spring 160 onto the housing 150 from above are formed in the pressing spring 160.

In assembling the light emitting device 10, firstly, the rise-up mirror 130 is mounted on the mirror mounting portion 150a within the housing 150. By performing the above operation, the rise-up mirror 130 is installed in the housing 150 with an inclination of 45 degrees in an in-plane direction of Y-Z plane with respect to X-Z plane.

Then, the lens holder 121 carrying the collimator lens 120 is placed on the paired slopes 150d in such a state that the groove 121e and the hole 150c are aligned with each other, whereby the lens holder 121 is housed within the housing 150. In the installation, the groove 121e and the hole 150c are aligned with each other by placing the lens holder 121 on the slopes 150d in such a manner that the protrusion 121d faces right above.

Then, the pressing spring 160 is abutted against an upper portion of the housing 150 in such a manner that the four screw holes 160b of the pressing spring 160 are aligned with the four screw holes 150g of the housing 150. In this state, four metal screws 161 are fastened into the four screw holes 150g from above via the four screw holes 160b. In the fastening, the protrusion 121d of the lens holder 121 is pressed downwardly by the step portion 160a of the pressing spring 160. By performing the above operation, the lens holder 121 is pressed against the slopes 150d of the housing 150 by the urging force of the pressing spring 160, whereby the lens holder 121 is temporarily fixed to be unmovable in X-axis direction (left and right directions) and in Y-axis direction (up and down directions).

When the pressing spring 160 is mounted in the housing 150, the protrusion 121d is positioned at the middle of the step portion 160a, and the pressing spring 160 is flexed equally in left and right directions with respect to the step portion 160a as a center. By performing the above operation, the lens holder 121 is less likely to cause positional displacement in a circumferential direction thereof. Further, in the case where the protrusion 121d is displaced from the middle of the step portion 160a, the lens holder 121 may be rotated in a circumferential direction thereof to such a position that the protrusion 121d is positioned at the middle of the step portion 160a, using the protrusion 121d as a marker. By performing the above operation, it is possible to align the groove 121e and the hole 150c with each other (see FIG. 5B).

As described above, when the lens holder 121 is temporarily fixed to the housing 150, there is formed a certain gap between the lens holder 121 and the inner side surface of the housing 150 so that the lens holder 121 is movable in Z-axis direction (front and rear directions).

Then, a rear surface of the laser holder 111 is abutted against the outer side surface of the housing 150 to such an extent that the CAN 110b of the laser light source 110 is inserted in the U-shaped opening 150b of the housing 150. In the insertion, three step portions 111b among the step portions 111b of the laser holder 111 shown in FIG. 4B, except for the upper-side step portion 111b, are in contact with the housing 150. There is formed a certain gap between the CAN 110b of the laser light source 110 and the opening 150b of the housing 150 so that the laser light source 110 is movable in X-axis direction and in Y-axis direction (up and down directions and left and right directions).

In the above state, the laser holder 111 is pressed against the housing 150 by using an XY-axes adjusting jig (not shown) to displace the laser light source 110 in X-axis direction and in Y-axis direction (up and down directions and left and right directions), whereby position adjustment in X-axis direction and in Y-axis direction (up and down directions and left and right directions) is performed. By performing the above operation, the optical axis of the laser light source 110 and the optical axis of the collimator lens 120 are aligned with each other. Further, a Z-axis adjusting jig (not shown) is engaged in the groove 121e of the lens holder 121 via the hole 150c formed in a lower portion of the housing 150, whereby position adjustment of the lens holder 121 in Z-axis direction (front and rear directions) is performed. By performing the above operation, the focal position of the collimator lens 120 is properly positioned with respect to a light emission point of the laser light source 110.

By performing the aforementioned position adjustment, an intended dot pattern is obtained in a target area.

After the position adjustment is performed as described above, a UV adhesive is applied equally in left and right directions to boundary portions between left and right two side surfaces of the laser holder 111 and the side surfaces of the housing 150. After the UV adhesive is applied, it is checked again whether there is a deviation of the optical axis of laser light. If it is confirmed that there is no problem of deviation, UV light is irradiated onto the UV adhesive, whereby the laser holder 111 is adhesively fixed to the housing 150. In the case where there is a problem of deviation of the optical axis of laser light, the position of the laser holder 111 is finely adjusted again, and UV light is irradiated onto the UV adhesive, whereby the laser holder 111 is adhesively fixed to the housing 150.

Further, the UV adhesive is applied equally in left and right directions at a position where the lens holder 121 and the slopes 150d in the inside of the housing 150 are in contact with each other via the holes 150e formed in the left and right side surfaces of the housing 150. After the application of the UV adhesive, the positional relation between the laser light source 110 and the collimator lens 120 is checked again. If it is confirmed that there is no problem of the positional relation, UV light is irradiated onto the UV adhesive, whereby the lens holder 121 is adhesively fixed to the housing 150. In the case where there is a problem of the positional relation between the laser light source 110 and the collimator lens 120, the position of the lens holder 121 is finely adjusted again, and then, UV light is irradiated onto the UV adhesive, whereby the lens holder 121 is adhesively fixed to the housing 150.

In this way, after installation of the laser light source 110 and the collimator lens 120 in the housing 150 is completed, the step portions 141b of the DOE holder 141 carrying the DOE 140 are received in the step portions 150f of the housing 150, and the DOE holder 141 is fixedly mounted in the housing 150. In this way, as shown in FIG. 5A, the assembling of the light emitting device 10 is completed. FIG. 5A is a perspective view of the light emitting device 10 when viewed from above, and FIG. 5B is a perspective view of the light emitting device 10 when viewed from below.

In the embodiment, the projection optical system 100 is configured in such a manner that the optical path of laser light emitted from the laser light source 110 is bent. Accordingly, the light emitting device 10 is configured to have a small height in Y-axis direction toward a target area, and have a long length in Z-axis direction. With this configuration, the surface area of the bottom surface among the outer side surfaces of the housing 150 becomes largest. In other words, a side surface of the housing 150, which is opposite to the reflecting direction of laser light by the rise-up mirror 130, has a largest surface area.

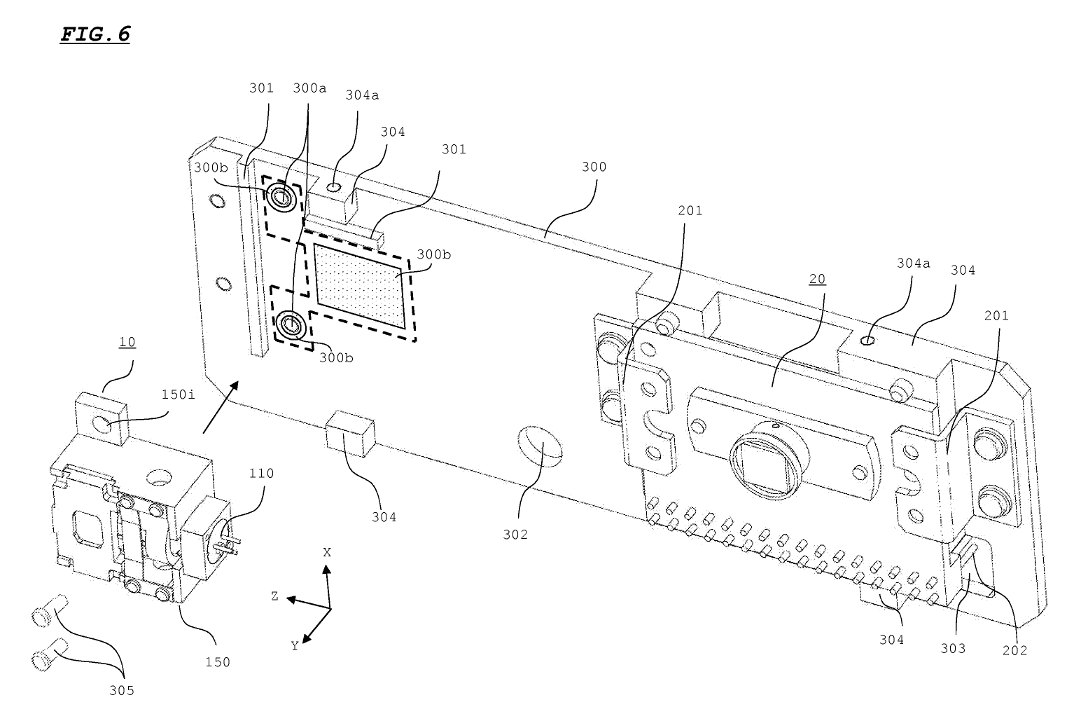

FIGS. 6 through 8B are perspective views showing an assembling process of the information acquiring device 1. To simplify the description, illustration of the assembling process of the light receiving device 20, and the mounting process of the light receiving device 20 onto the base plate 300 is omitted. The light receiving device 20 is a device constructed by assembling the light receiving optical system 200 shown in FIG. 2 and other components into one unit.

Referring to FIG. 6, the reference sign 300 denotes a base plate for supporting the light emitting device 10 and the light receiving device 20.

The light emitting device 10 and the light receiving device 20 are disposed on the base plate 300. As shown in FIG. 6, the base plate 300 has a rectangular plate-like shape. Further, the base plate 300 is made of stainless steel having a heat conductivity in the range of from 16.7 to 20.9 W/(m·K), and excellent flexibility resistance.

Two screw holes 300a for fixing the light emitting device 10 onto the base plate 300 are formed in the base plate 300. Further, the base plate 300 is formed with step portions 301 for determining the installation position of the light emitting device 10. The installation position of the light emitting device 10 is set in advance to such a position that the center of light emission of the light emitting device 10 and the center of light receiving of the light receiving device 20 are aligned with each other in Z-axis direction.

Further, the installation interval between the light emitting device 10 and the light receiving device 20 is set in accordance with a distance between the information acquiring device 1 and a reference plane of a target area. The distance between the reference plane and the information acquiring device 1 varies depending on a distance to a target object to be detected. As the distance to the target object to be detected decreases, the installation interval between the light emitting device 10 and the light receiving device 20 decreases. Conversely, as the distance to the target object to be detected increases, the installation interval between the light emitting device 10 and the light receiving device 20 increases.

As described above, the size of the base plate 300 increases in the alignment direction in which the light emitting device 10 and the light receiving device 20 are aligned. In the embodiment, the base plate 300 having such a large surface area is used as a heat sink for radiating heat generated in the light emitting device 10 for suppressing a temperature increase of the laser light source 110.

A heat radiating resin 300b is coated on a portion (see the dotted line portion in FIG. 6) of the base plate 300 which is in contact with the bottom surface of the housing 150 for enhancing the adhesiveness between the housing 150 and the base plate 300. The heat radiating resin 300b contains a heat conductive resin and metal powder, and has a heat conductivity in the range of from 3 to 4 W/(m·K). As compared with a PPS resin which is ordinarily used for a holder or the like and has a heat conductivity of about 0.4 W/(m·K), it is clear that the stainless steel of the base plate 300 and the heat radiating resin 300b have a sufficiently large heat conductivity.

A hole 302 is formed in the center of a lower portion of the base plate 300 for taking out a wiring of the laser light source 110 from a back portion of the base plate 300. Further, an opening 303 for exposing a connector 202 of the light receiving device 20 from the back portion of the base plate 300 is formed in the lower portion of the base plate 300 where the light receiving device 20 is installed. Further, as shown in FIG. 6, flange portions 304 are formed on the base plate 300, and screw holes 304a for fixing a cover 400 to be described later onto the base plate 300 are formed in the flange portions 304.

As shown in FIG. 2, the light receiving device 20 is provided with the filter 210, the aperture 220, the imaging lens 230, and the CMOS image sensor 240. The light receiving device 20 is fixed onto the base plate 300 by a substrate fixing portion 201. The connector 202 of the light receiving device 20 is exposed from a back surface of the base plate 300 via the opening 303 formed in the base plate 300.

The light emitting device 10 is disposed at such a position that the side surface of the housing 150 is in contact with the step portions 301 of the base plate 300. The light emitting device 10 is configured in such a manner that the bottom surface of the housing 150 is firmly adhered to the base plate 300 by the heat radiating resin 300b coated on the surface of the base plate 300. In this state, the two screw holes 300a and the two screw holes 150i are aligned with each other, and the two metal screws 305 are fastened into the two respective screw holes 150i and into the two respective screw holes 300a. The screws 305 are made of a metal having a high heat conductivity such as stainless steel. By performing the above operation, the light emitting device 10 is fixedly mounted onto the base plate 300.

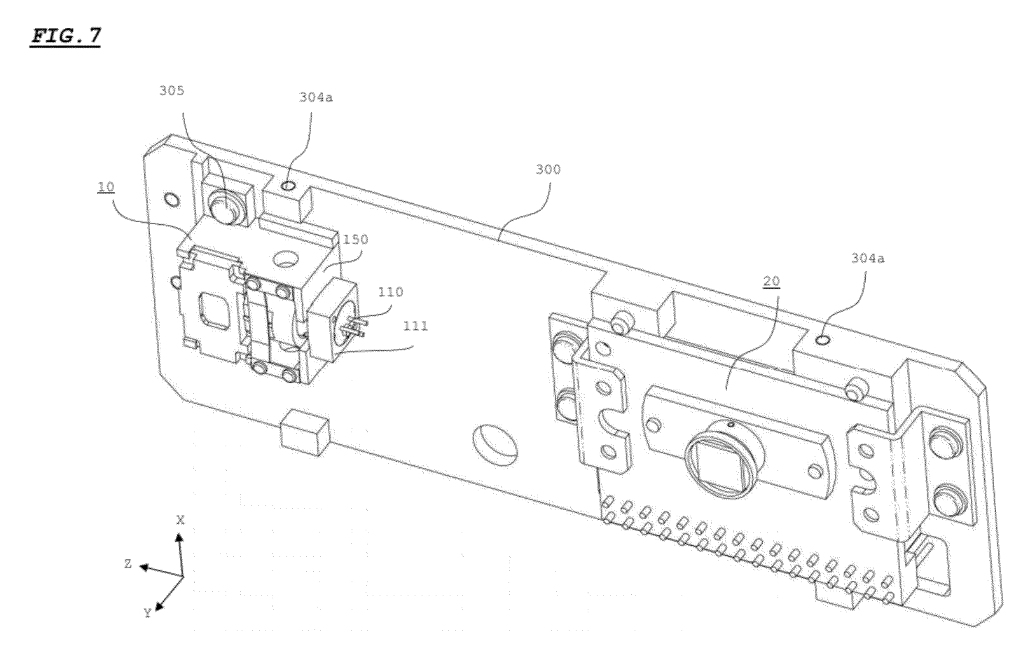

In this way, a structural member shown in FIG. 7 is assembled. As described above, the light emitting device 10 is configured in such a manner that the bottom surface of the housing 150 is firmly adhered and thermally connected to the surface of the base plate 300 by the heat radiating resin 300b. Further, since the housing 150 is firmly mounted on the base plate 300 by the metal screws 305, the housing 150 is thermally connected to the base plate 300 regardless of the existence of the screws 305.

Further, since the laser holder 111 is fixed to the outer side surface of the housing 150, the laser holder 111 is thermally connected to the housing 150.

With this arrangement, heat generated by light emission of the laser light source 110 is transferred to the base plate 300 by the screws 305 and the heat radiating resin 300b via the laser holder 111 and the housing 150. Thus, the heat transferred to the base plate 300 is radiated to the outside from the surface of the base plate 300.

In the embodiment, since the light emitting device 10 is configured to have large dimensions along the surface (X-Z plane) of the base plate 300, the surface area of the bottom surface of the housing 150 in contact with the surface of the base plate 300 is large. The amount of heat to be transferred between different materials increases in proportion to an increase in the surface area to be contacted. Consequently, the amount of heat to be transferred from the housing 150 to the base plate 300 is also large.

Further, the laser holder 111, the housing 150, the screws 305, and the heat radiating resin 300b, serving as a heat transfer route, are composed of a material having a high heat conductivity. Therefore, the light emitting device 10 is operable to efficiently transfer heat generated by light emission of the laser light source 110 to the base plate 300. Thereby, it is possible to obtain a sufficient heat radiation effect.

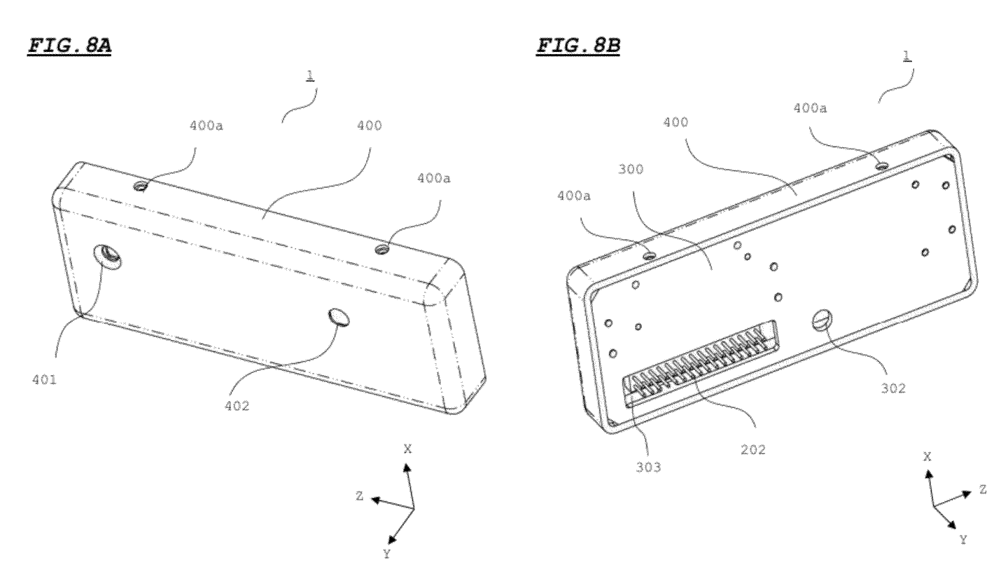

After the structural member shown in FIG. 7 is assembled, the cover 400 is mounted on the structural member (see FIG. 8A). In the mounting, the screw holes 304a of the base plate 300, and screw holes 400a of the cover 400 are aligned with each other, and the cover 400 is screw-fastened to the base plate 300. By performing the above operation, the assembling of the structural member shown in FIGS. 8A and 8B is completed. FIG. 8A is a perspective view of the structural member when viewed from front side, and FIG. 8B is a perspective view of the structural member when viewed from back side.

A light projecting window 401 for guiding light emitted from the light emitting device 10 to a target object, and a light receiving window 402 for guiding reflected light from the target object to the light receiving device 20 are formed in a front surface of the cover 400. Further, a circuit board 500 (not shown) is mounted on the back surface of the base plate 300. The laser light source 110 is connected to the circuit board 500 via the hole 302 formed in the back portion of the base plate 300. Further, the circuit board 500 is connected to the connector 202 of the light receiving device 20 via the opening 303 formed in the back portion of the base plate 300. The circuit section of the information acquiring device 1 such as the CPU 21 and the laser driving circuit 22 shown in FIG. 2 is mounted on the circuit board 500.

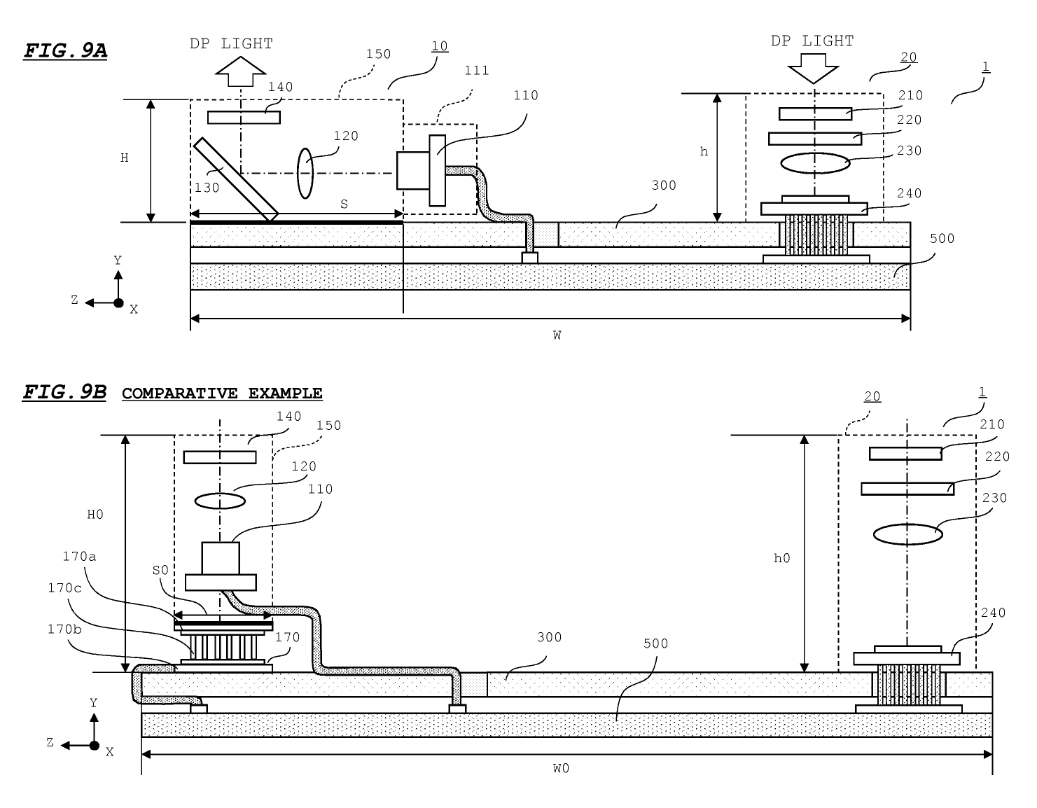

FIGS. 9A and 9B are schematic diagrams for respectively describing a heat radiation property of the light emitting device 10 in the embodiment, and a heat radiation property in a comparative example.

Referring to FIG. 9A, as described above, the laser light source 110 in the embodiment is disposed toward Z-axis direction. Laser light emitted from the laser light source 110 is collimated into parallel light by the collimator lens 120, and is reflected toward the DOE 140 by the rise-up mirror 130. Accordingly, the length of the alignment direction (Z-axis direction) in which the laser light source 110, the collimator lens 120, and the rise-up mirror 130 are aligned increases, and the height H in a direction (Y-axis direction) toward a target area decreases. Therefore, the surface area S of the bottom surface of the housing 150 which is in contact with the surface of the base plate 300 increases.

FIG. 9B shows an arrangement example, as a comparative example, wherein the laser light source 110 is not disposed toward Z-axis direction, and the optical elements of the projection optical system 100 is aligned in a direction (Y-axis direction) toward a target area. In the comparative example, since the surface area SO of the housing 150 which is in contact with the base plate 300 is small, a Peltier element 170 is disposed between the housing 150 and the base plate 300. Elements in the comparative example which are substantially the same as in the embodiment are indicated with the same reference signs as in the embodiment.

The Peltier element 170 is configured in such a manner that n-type/p-type thermoelectric semiconductor elements 170c electrically connected to electrodes are interposed between a ceramic insulating substrate 170a and a ceramic insulating substrate 170b. The Peltier element 170 has a function of absorbing heat generated in the laser light source 110 from the ceramic insulating substrate 170a which is in contact with the housing 150 by flowing an electric current to the n-type/p-type thermoelectric semiconductor elements 170c, and transferring the heat to the ceramic insulating substrate 170b. By performing the above operation, the Peltier element 170 radiates heat generated in the laser light source 110 to the outside via the base plate 300 also functioning as a heat sink.

However, the Peltier element 170 itself produces heat for transferring heat from the ceramic insulating substrate 170a to the ceramic insulating substrate 170b. As a result, the heat radiation amount of the light emitting device 10 as a whole increases, which may obstruct the base plate 300 also functioning as a heat sink from smoothly radiating heat. In such a case, as shown in FIG. 9B, it is necessary to make the size W0 of the base plate 300 larger than the size W of the base plate 300 as shown in the embodiment.

Further, as shown in FIG. 9B, it is necessary to dispose the Peltier element 170 beneath the housing 150 for effectively transferring heat generated in the laser light source 110. In addition to the above, all the optical elements of the projection optical system 100 are aligned in the optical axis direction of laser light. As a result, the height H0 of the projection optical system 100 in a direction (Y-axis direction) toward a target area in the comparative example is considerably higher than the height H of the projection optical system 100 in the embodiment.

Furthermore, the height h0 of the light receiving optical system 200 also increases, as the height H0 of the projection optical system 100 increases, because it is necessary to align the positions of the center of light emission of the projection optical system 100 and the center of light receiving of the light receiving optical system 200 with each other in Z-axis direction.

In the comparative example, the heat conductivities of the ceramic insulating substrates 170a, 170b of the Peltier element 170 which are in contact with the bottom surface of the housing 150 are ordinarily larger than the heat conductivity of the stainless steel base plate 300 in contact with the housing 150, which lies in the range of from 16.7 to 20.9 W/(m·K). However, in the embodiment, the surface area S of the bottom surface of the housing 150 which is in contact with the base plate 300 is considerably large as compared with the surface area S0 of the housing 150 which is in contact with the ceramic insulating substrate 170a of the Peltier element 170 in the comparative example. As the surface area to be contacted increases, the amount of heat to be transferred between different materials increases in proportion to the increase in the surface area to be contacted. Accordingly, the embodiment is advantageous in obtaining a sufficient heat radiation effect without providing the Peltier element 170.

As described above, in the embodiment, the optical elements from the laser light source 110 to the rise-up mirror 130 is disposed in parallel to the surface of the base plate 300. Accordingly, the height of the housing 150 for housing the projection optical system 100 decreases in a direction toward a target area, and the surface area of the bottom surface of the housing 150 which is in contact with the surface of the base plate 300 also functioning as a heat sink increases. Thereby, the thickness of the light emitting device 10 can be reduced, and a sufficient heat radiation property can be obtained.

Further, in the embodiment, the laser holder 111, the housing 150, and the screws 305 serving as a transfer route of heat generated in the laser light source 110 are made of a material having a high heat conductivity. Accordingly, it is possible to efficiently transfer heat generated by light emission of the laser light source 110 to the base plate 300.

Further, in the embodiment, as shown in FIG. 5A, for instance, the laser holder 111 is mounted in the housing 150 in such a manner that the side surface of the laser holder 111 is placed over the side surface of the housing 150. Accordingly, heat of the laser light source 110 is transferred to the housing 150 via the side surface of the laser holder 111 is placed over the side surface of the housing 150. Thus, it is possible to enhance the heat radiation effect with respect to the laser light source 110.

Further, in the embodiment, a sufficient heat radiation property can be obtained without providing a temperature adjusting element such as a Peltier element. Accordingly, it is possible to reduce the total amount of heat radiation of the base plate 300, and properly perform a heat radiation operation even if the base plate 300 is relatively small.

Further, in the embodiment, the thickness of the light emitting device 10 can be reduced in a direction toward a target area. Accordingly, it is possible to reduce the thickness of the light receiving device 20.

Further, in the embodiment, it is possible to reduce the number of parts by allowing the base plate 300 to also function as a heat sink.

Further, in the embodiment, the base plate 300 has flexibility resistance and is made of a material having a high heat conductivity. Accordingly, it is possible to reduce the thickness of the base plate and efficiently radiate transferred heat.

Further, in the embodiment, the heat radiating resin 300b having a high heat conductivity is coated between the housing 150 and the base plate 300. Accordingly, the housing 150 and the base plate 300 are firmly adhered and thermally connected to each other. Thus, it is possible to efficiently transfer heat from the housing 150 to the base plate 300.

The embodiment of the invention has been described as above. The invention is not limited to the foregoing embodiment, and the embodiment of the invention may be changed or modified in various ways other than the above.

For instance, in the embodiment, a metal such as zinc or magnesium having a high heat conductivity is used as a material for the laser holder 111 and the housing 150. In the embodiment, it is possible to use a heat radiating PPS resin having a heat conductivity in the range of from about 20 to 30 W/(m·K), taking into consideration that the heat radiating PPS resin is capable of increasing the surface area to be contacted with a heat sink and has a high heat radiation property. The heat radiating PPS resin is a resin obtained by containing metal particles in PPS resin for enhancing the heat radiation property. Taking into consideration that the heat conductivity of ordinary PPS resin is about 0.4 W/(m·K) and the heat conductivity of stainless steel is in the range of from 16.7 to 20.9 W/(m·K), it is clear that the heat radiating PPS resin has a significantly high heat radiation property. Thus, the modification is advantageous in reducing the manufacturing cost of the light emitting device 10, as compared with the embodiment.

Further, the materials for the members such as the laser holder 111, the housing 150, and the base plate 300 as described in the embodiment are merely examples. These members may be made of a material other than the materials described in the embodiment, or an alloy obtained by combining these materials. For instance, the housing 150 may be made of aluminum whose heat conductivity is 237 W/(m·K), in place of zinc or magnesium. Aluminum has a high heat conductivity and is inexpensive, although the molding precision is low as compared with zinc or magnesium used in the embodiment, and secondary processing is necessary. Further, the base plate 300 may be made of copper whose heat conductivity is 398 W/(m·K), in place of stainless steel. Copper has a high heat conductivity, although it is necessary to increase the thickness of the base plate 300 because of low flexibility resistance, as compared with stainless steel. Accordingly, use of copper is advantageous in obtaining an enhanced heat radiation property.

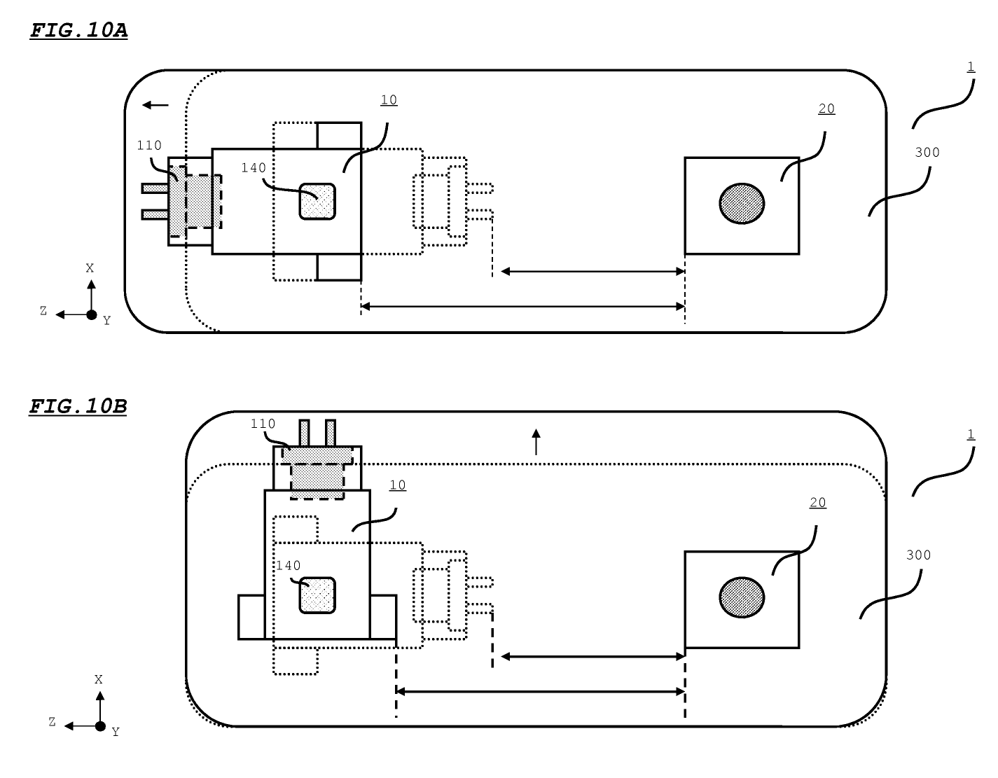

Further, in the embodiment, the laser light source 110 is disposed at a position closer to the light receiving device 20 with respect to the DOE 140. Alternatively, as shown in FIG. 10A, the laser light source 110 may be disposed at a position farther from the light receiving device 20 with respect to the DOE 140. Further alternatively, as shown in FIG. 10B, the laser light source 110 may be disposed at such a position that the optical axis of the laser light source 110 is orthogonal to the alignment direction in which the light emitting device 10 and the light receiving device 20 are aligned. As shown in FIGS. 10A and 10B, disposing the laser light source 110 at a position near a periphery of the base plate 300 makes it easy to radiate heat in the laser light source 110, whereby the heat is less likely to stay within the information acquiring device 1. However, in the arrangements shown in FIGS. 10A and 10B, as compared with the embodiment, the size of the base plate 300 increases in Z-axis direction or in X-axis direction.

Further, as the reference plane of a target area comes close, the interval between the light emitting device 10 and the light receiving device 20 is shortened. This makes it difficult to dispose the laser light source 110 between the light emitting device 10 and the light receiving device 20. In such a case, the laser light source 110 may be disposed as shown in FIGS. 10A and 10B. In the case where the reference plane of a target area is located at a position sufficiently far, it is possible to reduce the dimensions of the base plate 300 by disposing the laser light source 110 at a position closer to the light receiving device 20 as described in the embodiment, because a sufficient space can be secured between the light emitting device 10 and the light receiving device 20 in the embodiment.

As described above, as far as a relative position between the DOE 140 (center of light emission) and the light receiving device 20 (center of light receiving) is retained unchanged, it is possible to dispose the laser light source 110 in any direction in an in-plane direction in parallel to the surface of the base plate 300 depending on a condition.

Further, in the embodiment, only the step portions 111b of the laser holder 111 are in contact with the outer side surface of the housing 150. Alternatively, the laser holder 111 may be directly in contact with the outer side surface of the housing 150, without forming the step portions 111b. The modification is advantageous in efficiently transferring heat generated in the laser holder 111 to the housing 150, as compared with the embodiment. Further alternatively, a heat radiating resin may be interposed between the laser holder 111 and the outer surface of the housing 150. Further alternatively, the laser light source 110 may be directly housed in the housing 150 without providing the laser holder 111.

Further, in the embodiment, the hexahedron-shaped housing 150 having rectangular shapes in cross sections in in-plane directions perpendicular and parallel to the optical axis of the laser light source 110 is used. Alternatively, a hexahedron-shaped housing having a trapezoidal shape in cross section, or a hexahedron-shaped housing having a polygonal shape in cross section may be used. In the modification, it is possible to efficiently radiate heat in the laser light source 110 in the same manner as in the embodiment by configuring the housing to such a shape that a surface of the housing having a largest surface area is in contact with the base plate 300.

Further, in the embodiment, the rise-up mirror 130 is used for reflecting laser light to be emitted toward Z-axis direction in a direction toward a target area. Alternatively, a polarized beam splitter or a leakage mirror for reflecting a part of entered light may be used, in place of the rise-up mirror 130.

Further, in the embodiment, the CMOS image sensor 240 is used as a light receiving element. Alternatively, a CCD image sensor may be used in place of the CMOS image sensor 240. Further alternatively, the arrangement of the light receiving optical system 200 may be modified, as necessary. Further alternatively, the information acquiring device 1 and the information processing device 2 may be integrally configured into one unit, or the information acquiring device 1 and the information processing device 2 may be integrally configured with a television, a game machine, or a personal computer.

The embodiment of the invention may be changed or modified in various ways as necessary, as far as such changes and modifications do not depart from the scope of the claims of the invention hereinafter defined.

What is claimed is:

1. An information acquiring device, comprising:
a light emitting device which irradiates a target area with laser light having a dot pattern;
a light receiving device which is disposed in alignment with the light emitting device, and captures an image of the target area; and
a support plate on which the light emitting device and the light receiving device are mounted, the support plate having a heat conductivity,
the light emitting device including:
a laser light source;
a collimator lens which converts laser light emitted from the laser light source into parallel light;
a diffractive optical element which converts laser light converted as the parallel light into laser light having the dot pattern;
a mirror which reflects the laser light transmitted through the collimator lens in a direction toward the diffractive optical element; and
a housing which holds the laser light source, the collimator lens, the mirror and the diffractive optical element in such a manner as to linearly align the laser light source, the collimator lens and the mirror, the housing having a heat conductivity, wherein
a side surface of the housing opposite to a reflecting direction of laser light by the mirror is formed into a flat surface, and
the housing is mounted on the support plate in such a manner that the flat surface is placed on a top surface of the support plate.

2. The information acquiring device according to claim 1, wherein
a heat radiating resin is coated on the top surface of the support plate on which the flat surface of the housing is placed.

3. The information acquiring device according to claim 1, wherein
the housing is a casing having an opening opened upwardly for housing the laser light source, the collimator lens and the mirror therein, and
a lower surface of the casing is placed on the top surface of the support plate.

4. The information acquiring device according to claim 1, wherein
the laser light source is mounted in the housing via a laser holder having a heat conductivity, and
the laser holder is mounted in the housing in such a manner that a side surface of the laser holder is placed over a side surface of the housing.

5. The information acquiring device according to claim 4, wherein
the housing is mounted on the support plate in such a manner that the laser light source is located closer to the light receiving device than the mirror.

6. An object detecting device, comprising:
an information acquiring device,
the information acquiring device including:
a light emitting device which irradiates a target area with laser light having a dot pattern;
a light receiving device which is disposed in alignment with the light emitting device, and captures an image of the target area; and
a support plate on which the light emitting device and the light receiving device are mounted, the support plate having a heat conductivity,
the light emitting device including:
a laser light source;
a collimator lens which converts laser light emitted from the laser light source into parallel light;
a diffractive optical element which converts laser light converted as the parallel light into laser light having the dot pattern;
a mirror which reflects the laser light transmitted through the collimator lens in a direction toward the diffractive optical element; and
a housing which holds the laser light source, the collimator lens, the mirror and the diffractive optical element in such a manner as to linearly align the laser light source, the collimator lens and the mirror, the housing having a heat conductivity, wherein
a side surface of the housing opposite to a reflecting direction of laser light by the mirror is formed into a flat surface, and
the housing is mounted on the support plate in such a manner that the flat surface is placed on a top surface of the support plate.

7. The object detecting device according to claim 6, wherein
a heat radiating resin is coated on the top surface of the support plate on which the flat surface of the housing is placed.

8. The object detecting device according to claim 6, wherein
the housing is a casing having an opening opened upwardly for housing the laser light source, the collimator lens and the mirror therein, and
a lower surface of the casing is placed on the top surface of the support plate.

9. The object detecting device according to claim 6, wherein
the laser light source is mounted in the housing via a laser holder having a heat conductivity, and
the laser holder is mounted in the housing in such a manner that a side surface of the laser holder is placed over a side surface of the housing.

10. The object detecting device according to claim 9, wherein
the housing is mounted on the support plate in such a manner that the laser light source is located closer to the light receiving device than the mirror.
